(19) United States
(12) Patent Application Publication
(10) Pub. No.: US 2003/0074270 A1
(43) Pub. Date: Apr. 17, 2003

(54) Computerized method and system for managing and communicating information regarding an order of goods

(76) Inventors: Otis F. Brown, Prospect, KY (US); Timothy W. Howard, Louisville, KY (US); Jeffrey L. Stitt, Louisville, KY (US); Betty Shea, Shepherdsville, KY (US)

Correspondence Address: BEUSSE, BROWNLEE, BOWDOIN & WOLTER, P. A., 390 NORTH ORANGE AVENUE, SUITE 2500, ORLANDO, FL, 32801, US

(21) Appl. No.: 09/981,413

(22) Filed: Oct. 16, 2001

(51) Int. Cl. G06F 17/60

(52) U.S. Cl. 705/26

(57) ABSTRACT

Computerized method and system for managing and communicating information regarding an order of goods among respective various teams are provided. The teams are responsible for performing tasks through designated personnel that, when successfully performed, allow for fulfilling an order within a requested delivery date. The method allows for storing order data in a database. The order data includes at least one identifier associating a respective order to a respective customer. The order data further includes order parameters, such as a requested delivery date or a customer need date for the ordered goods. The method further allows for gathering in the database data indicative of progress or lack thereof for each order relative to the requested delivery date. Memory is provided for storing a rulebase including a set of rules configured to determine at least a potential cause impeding progress of any order relative to its respective requested delivery date. The set of rules is processable to assign an order and/or a corrective action to selected personnel in a respective team, based, at least in part, on the nature of the cause impeding order progress. A processing action allows processing the gathered data in the database relative to the rulebase for performing the assignment of the order and/or corrective action to the selected personnel in the event lack of order progress is determined. A message is triggered to notify the selected personnel of the assignment of the corrective action.

### BACKGROUND OF THE INVENTION

The present invention is generally related to computer-based tools and techniques for implementing business processes, and, more particularly, to computerized method and system for managing and communicating information regarding an order of consumer goods.

Service quality has become almost as important to many customers as the quality of the manufactured or supplied goods. Increasingly, customers tend to make purchasing decisions based, at least in part, upon the service performance of suppliers. Thus, it is very important for suppliers of goods, such as the assignee of the present invention, to be able to have computerized tools that accurately and inexpensively allow for implementing techniques that are conducive to systematically meeting the unique service needs of each customer.

On-time product delivery is an important service component of many high-volume supply businesses. A customer typically orders a product for delivery on a specified date. The customer expects that the delivery will be no later than that date. Similarly, the customer also does not want the delivery to be too early. The customer considers the delivery to be on time only if it is within a relatively narrow time window. See article by Constance L. Hays, New York Times at C1 and C5, Aug. 17, 2001, titled “Send it Right The First Time: Manufacturers and Retailers Fight Over Shipping” for a recent account of the enormous business stakes involved and expensive disputes that can arise when goods are not sent as requested by the purchaser.

Typically, high-volume operations for delivering goods to a customer generally require the involvement of several order-processing teams of the supplier. Each team being specifically responsible for performing a set of tasks through designated personnel for fulfilling each order within a requested delivery date. For example, there may be a team responsible for interacting with the customer and gathering the required information for accepting orders, i.e., an order entry team. There may be a team responsible for managing inventory logistics and ensuring availability of the specific models ordered by the customer, i.e., goods availability team. There may be a team responsible for managing the transportation logistics of physically shipping the goods to an appropriate distribution center, i.e., a distribution team. It will be appreciated that close coordination among the various team members or personnel that make up each of these teams is vital to ensuring that each order timely progresses relative to the requested delivery date.

It is known that even in the best organized business operations, events will arise from to time to time that if not appropriately addressed will jeopardize the requested delivery date of the goods. For example, in high-volume operations by the time a given order is identified and assigned to the appropriate personnel in any of the order-processing teams for solving one or more issues impeding order progress, often the requested delivery date has already been missed. Further, in many instances there are not any procedures in place that would allow for quickly and inexpensively tracking whether the assigned personnel has been able to solve the issues without slowing or stopping the progress of the order. Often, the assigned personnel for processing the order may be located in remote locations from one another. Thus, in the event a given team member is unable to resolve the issues impeding progress of the order, it has been difficult to quickly and accurately identify the supervisory personnel that should be involved if escalation to resolve the issues becomes necessary. Moreover, present techniques are believed not to provide any computer-processable business rules that would allow for objectively and automatically escalating the order to the supervisory personnel to avoid creating a festering aged-order condition. Thus, it is desirable to provide method and system that takes advantage of the speed and accuracy of computers for processing and communicating information that allows for accurately and inexpensively solving the above-discussed issues.

### BRIEF SUMMARY OF THE INVENTION

Generally, one aspect of the present invention, fulfills the foregoing needs by providing a computerized method for managing and communicating information regarding an order of goods among a plurality of teams responsible for performing tasks through designated personnel that, when successfully performed, allow for fulfilling an order within a requested delivery date. The method allows for storing order data in a database. The order data includes at least one identifier associating a respective order to a respective customer. The order data further includes a requested delivery date for the ordered goods. The method further allows for gathering in the database data indicative of progress or lack thereof for each order relative to the requested delivery date. Memory is provided for storing a rulebase including a set of rules configured to determine at least a potential cause impeding progress of any order relative to its respective requested delivery date. The set of rules is processable to assign an order and/or a corrective action to selected personnel in a respective team, based, at least in part, on the nature of the cause impeding order progress. A processing action allows processing the gathered data in the database relative to the rulebase for performing the assignment of order and/or the corrective action to the selected personnel in the event lack of order progress is determined. A message is triggered to notify the selected personnel of the assignment of the order and/or corrective action.

The present invention further fulfils the foregoing needs by providing in another aspect thereof, a computerized system for managing and communicating information regarding an order of goods among a plurality of teams responsible for performing tasks through designated personnel that, when successfully performed, allow for fulfilling an order within a requested delivery date. The system includes a database comprising order data including at least one identifier associating a respective order to a respective customer. The order data includes a requested delivery date for the ordered goods. The database is also used for gathering data indicative of progress or lack thereof for each order relative to the requested delivery date. The system further includes memory for storing a rulebase including a set of rules configured to determine at least a potential cause impeding progress of any order relative to its respective requested delivery date. The set of rules is processable to assign an order and/or a corrective action to selected personnel in a respective team, based, at least in part, on the nature of the cause impeding order progress. A processor is configured to process the gathered data in the database relative to the rulebase for performing the assignment of the order and/or corrective action to the selected personnel in the event lack of order progress is determined. The processor is further configured to trigger a message notifying the selected personnel of the assignment of the order and/or corrective action.

### DESCRIPTION OF THE DRAWINGS

FIG. 1 illustrates a schematic representation of an exemplary system that may be used for practicing a computerized method in accordance with aspects of the present invention.

FIGS. 2 and 3 illustrate exemplary notification messages automatically sent to selected personnel via communications network to notify such personnel of assignments for taking an order and/or corrective actions regarding issues that, if left uncorrected, would cause aged orders relative to a requested delivery date.

FIGS. 4 and 5 respectively illustrate a respective interface medium, such as a Web page, that includes detailed information regarding orders experiencing little or no progress for meeting the requested delivery date.

FIGS. 6 and 7 respectively illustrate a screen that can provide to personnel and/or teams involved in ordering operations a snapshot view of the progress or lack of progress for orders and/or actions under their responsibility.

### DETAILED DESCRIPTION OF THE INVENTION

FIG. 1 illustrates an exemplary schematic representation of a system 100 that may be used for practicing a computerized method for managing and communicating information regarding an order of consumer goods among a plurality of teams responsible for performing tasks through designated personnel that, when successfully performed, allow for fulfilling an order within a requested delivery date. System 100 includes devices that cooperate in a manner that, in one exemplary embodiment, allows for seamlessly integrating a logistical supply chain through a communication network 102, such as a local area network (LAN), wide area network (WAN), intranet, or the Internet. In one exemplary embodiment, remote terminals 104 using commercially available browsers, and Web-based applications are provided to each order-processing team of the supplier. The remote terminal may comprise a personal computer, a laptop computer, a personal digital assistance (PDA) device, cellular telephone or any other wired or wireless device that enables communication of computer-readable data. Although the description below makes reference to Web-based applications, it will be apparent that such a reference is to be construed as illustrative and should not be construed as a limitation of the present invention. It will be understood that the expression “order of goods” as used herein is not limited to the purchase of the goods themselves since it is contemplated that services, e.g., installation, repair, maintenance, etc., provided in connection with the supplied goods may similarly benefit from the method and system of the present invention.

By way of example, the logistical supply chain may comprise consumer purchasers of goods, a supplier manufacturer of the goods, such as the GE Appliances business organization of the assignee of the present invention, retailers of the goods, such as Walmart stores, etc., and other intermediaries that may facilitate the delivery of the goods from the manufacturer to the customer. As suggested above, the operations for delivering goods to a customer generally require the involvement of several order-processing teams of the supplier. Each team may be responsible for performing a set of tasks through designated personnel for fulfilling each order within a requested delivery date. For example, the order entry team may be responsible for interacting with the customer and gathering the required information for accepting orders, e.g., payment data, delivery information, etc. The goods availability team may be responsible for managing inventory logistics and ensuring availability of the specific models ordered by the customer, e.g., this team may coordinate with manufacturing operations when an existing model is being phased out and eventually superceded by a newer model; or may coordinate as to the supply of goods from alternate sources in the event force majeure events prevent fulfillment of an order. The distribution team may be responsible for managing the transportation logistics of physically shipping the goods to an appropriate distribution center.

As illustrated in FIG. 1, system 100 includes a database 106 comprising order data including at least one identifier associating a respective order to a respective customer. The order data includes a requested delivery date for the ordered goods. Those skilled in the art will understand that other parameters may be used in lieu of requested delivery date. For example, one could use a “customer need date” instead of “requested delivery date.” Thus, the expression “requested delivery date” should be broadly construed to encompass any other linguistic expressions indicative of the timing for fulfilling an order. The database is also used for gathering data, e.g., predefined codes indicative of progress or lack of progress for each order relative to the requested delivery date. The system further includes a memory 108 for storing a rulebase 110 including a set of business rules 114 configured to identify at least a potential cause impeding progress of any order relative to its respective requested delivery date and determine a corrective action for the identified cause. The set of rules 114 is processable to assign an order and/or corrective action to selected personnel in a respective team, based, for example, on the nature of the cause impeding order progress. A processor 112 is configured to process the gathered data in the database 106 relative to the rulebase for performing the assignment of the order and/or corrective action to the selected personnel in the event lack of order progress is determined. For example, if the paper work with a respective order includes incorrect information that impedes clearing the payment of the order, e.g., an incorrect credit card number, then selected personnel within the order-entry team will be assigned to correct this issue. Similarly, if the model selected by the customer is not presently available, then selected personnel within the goods-availability team will be assigned to correct this issue. The rulebase further includes a set of escalation rules 116 for progressively assigning corrective actions to higher levels of supervisory personnel based on lack of progress severity ratings assigned to a respective order. For example, in the event a given team member is unable to resolve the issues impeding progress of the order, the escalation rules allows for automatically escalating the order to the appropriate supervisory personnel that should be involved if escalation to resolve the issues becomes necessary. The processor includes a notifier module 118 configured to trigger a message notifying the selected personnel of the assignment of the order and/or corrective action. The notifier may also include summary level order tracking and communications for operating personnel and senior management. The notification could take place by any suitable communication means, such as e-mail, fax, telephonic communication, etc.

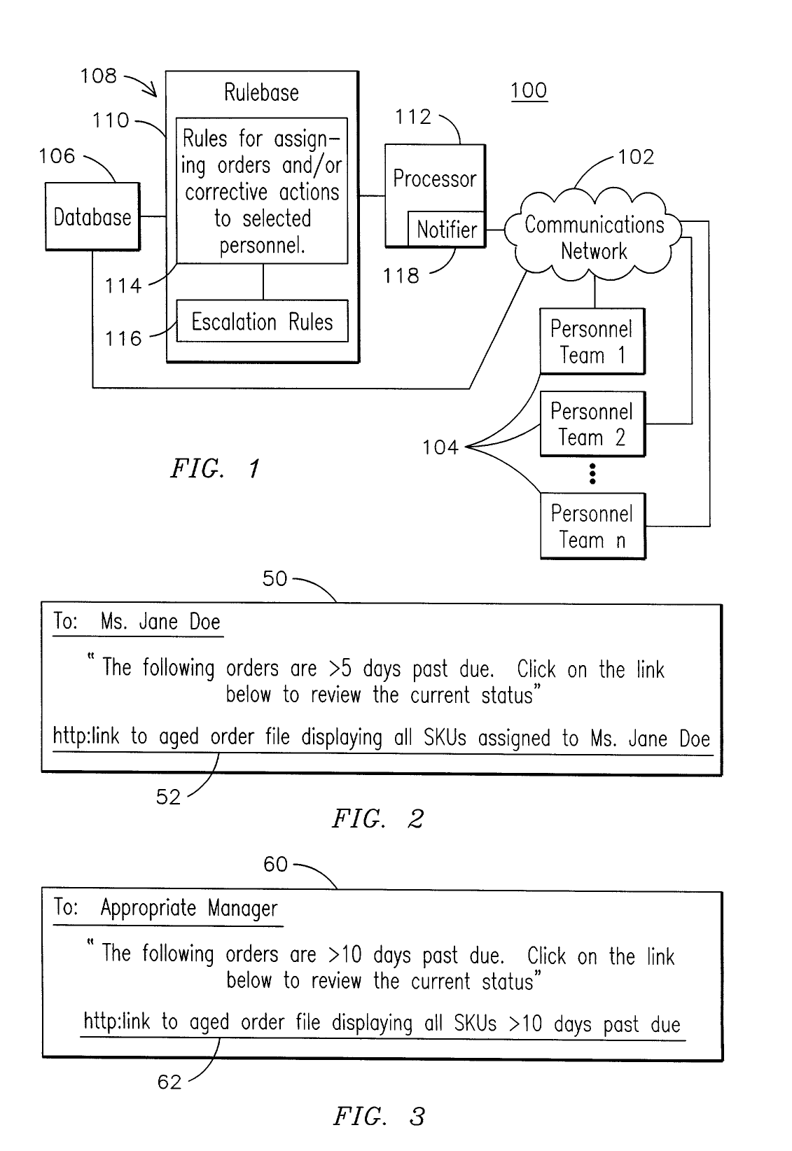

FIGS. 2 and 3 illustrate exemplary notification messages 50 and 60 sent to the selected personnel, e.g., via communications network 102 (FIG. 1). For example, notification message 50 notifies Ms. Jane Doe that a number of orders or items (e.g., 175) are five days past a due date and action needs to be taken by Ms. Doe to correct the cause/s of lack of order progress. Message 50 includes a clickable link 52 that allows Ms. Doe to access the database 106 and determine the status of the orders being assigned to her.

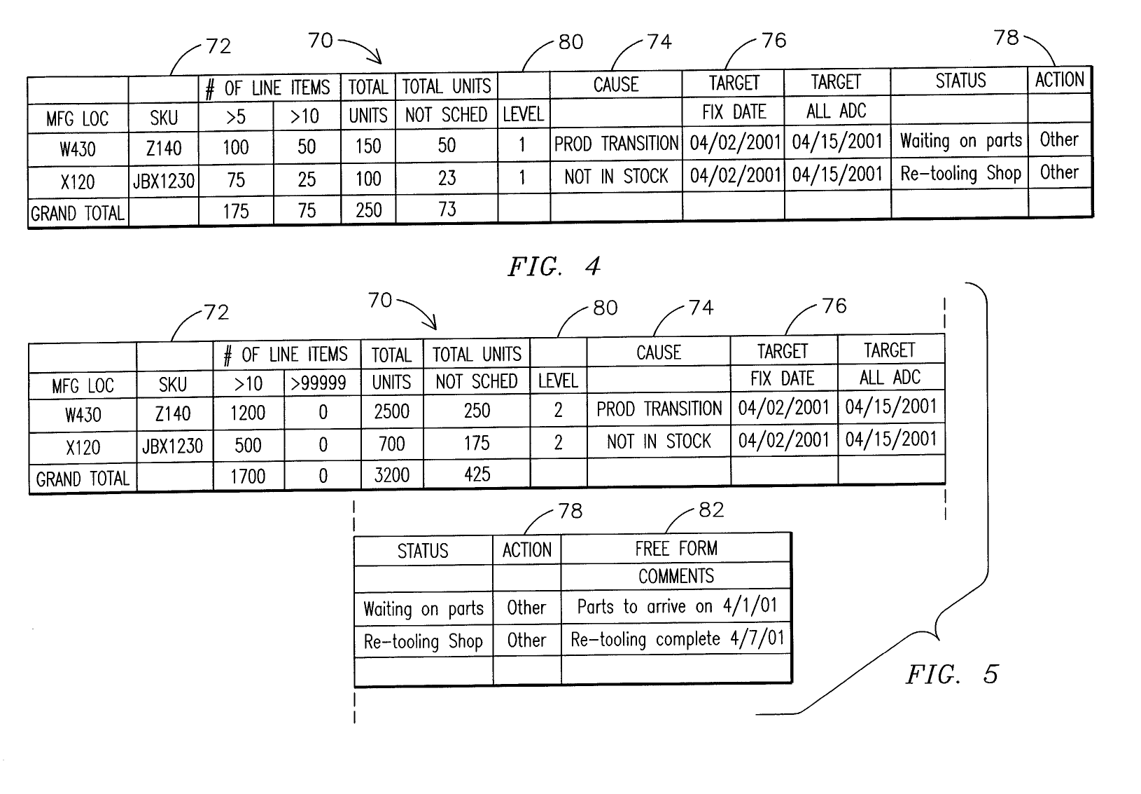

FIG. 4 illustrates an exemplary computer interface medium 70, such as a Web page. The Web page or other suitable interface medium includes detailed information regarding the actual items experiencing little or no progress for meeting the requested delivery date, and assigned to Ms. Doe for corrective action. In one exemplary representation, the Web page may include a data field 72 with a suitable identifier of the product lines involved, (e.g., an SKU identifier) an order number (an MS identifier), or both. The Web page may further include a data field 74 identifying potential causes causing the lack of progress of the order. A data field 76 includes a target date for performing the corrective action. A data field 78 is provided for recording actions actually taken by the selected personnel to remove the lack of order progress. A data field 80 includes lack of progress severity ratings based, for example, on continuing lack of progress beyond the target completion date. For example, the level one ratings in the message to Ms. Doe may correspond to the lowest lack of progress severity ratings.

By way of comparison, notification message 60 (FIG. 3) would be sent to notify an appropriate manager in the event Ms. Jane Doe was unable to correct the items previously identified as being five days past the due date. In this case, the manager would be informed of items that are ten days overdue. Message 60 includes a clickable link 62 that allows the manager to access the database 106 and determine the status of the items being assigned to him or her. As shown in FIG. 5, the data field 80 includes a lack of progress severity ratings that has been escalated from the level one ratings to the next higher ratings, e.g., a level two ratings indicating that even though corrective action was requested from Ms. Jane Doe, the items continue outstanding. It will be appreciated that further escalations to higher levels of management could be triggered, were the items continue to remain open after further requests of corrective action. The web page may include a data field 82 where the selected personnel may insert comment information to elaborate regarding corrective actions or recommendations provided in connection with a given order. The above example assumes that a business rule would trigger a first message to the selected personnel upon the order being five days overdue, and further assumes that orders would be escalated to the next higher level when the orders are ten days overdue. It will be understood, however, that the present invention is not limited to any particular time window, since one of ordinary skill in the art would be able to adjust any such time windows based on the requirements of any given business application.

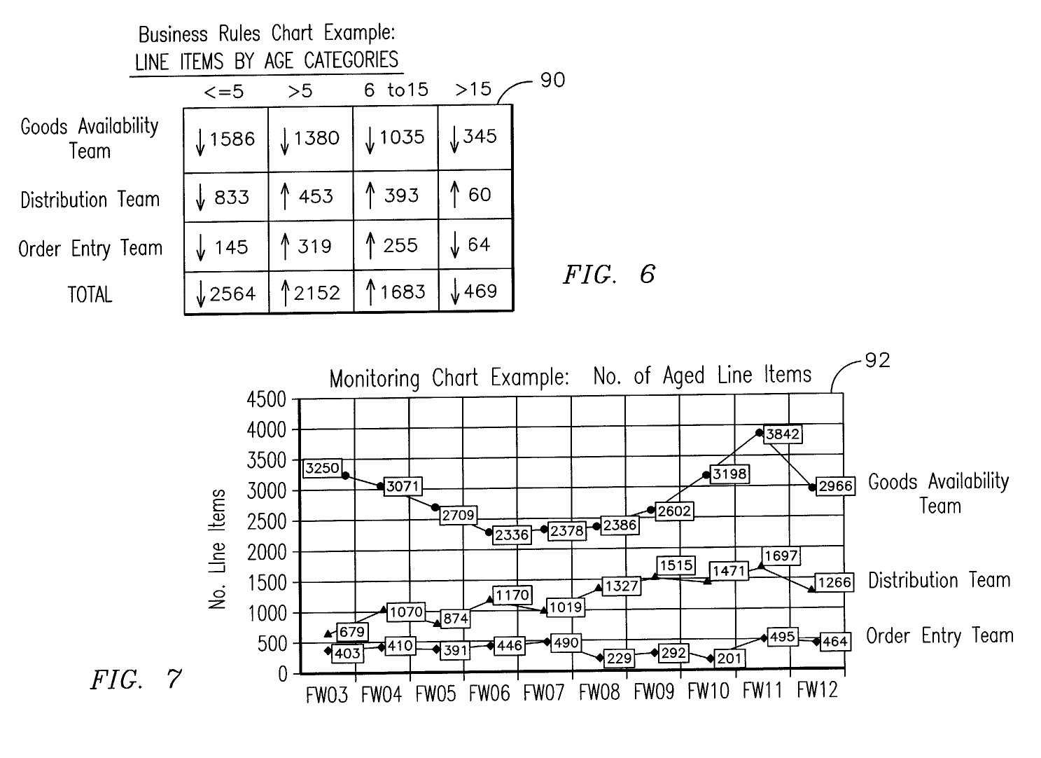

FIGS. 6 and 7 illustrate respective screens 90 and 92 that can provide to the various personnel and teams involved in the multiple ordering operations a snapshot view of the progress or lack of progress for tasks under their responsibility. For example, screen 90 illustrates a table that classifies each order both as a function of team responsibility and number of days that the order is overdue relative to a particular objective. Screen 92 illustrates a plot of aged orders as a function of time and broken down for each of the teams involved in the order operations.

The present invention can be embodied in the form of computer-implemented processes and apparatus for practicing those processes. The present invention can also be embodied in the form of computer program code including computer-readable instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. When implemented on a computer, the computer program code segments configure the computer to create specific logic circuits or processing modules.

While the preferred embodiments of the present invention have been shown and described herein, it will be obvious that such embodiments are provided by way of example only. Numerous variations, changes and substitutions will occur to those of skill in the art without departing from the invention herein. Accordingly, it is intended that the invention be limited only by the spirit and scope of the appended claims.

What is claimed is:

1. A computerized method for managing and communicating information regarding an order of goods among a plurality of teams responsible for performing tasks through designated personnel that, when successfully performed, allow for fulfilling an order within a requested delivery date, the method comprising:
storing order data in a database, the order data including at least one identifier associating a respective order to a respective customer, the order data further including a requested delivery date for the ordered goods;
gathering in the database data indicative of progress or lack thereof for each order relative to the requested delivery date;
providing memory for storing a rulebase including a set of rules configured to determine at least a potential cause impeding progress of any order relative to its respective requested delivery date, the set of rules being processable to assign an order and/or a corrective action to selected personnel in a respective team, based, at least in part, on the nature of the cause impeding order progress; and
processing the gathered data in the database relative to the rulebase for performing the assignment of the order and/or corrective action to the selected personnel in the event lack of order progress is determined; and
triggering a message notifying the selected personnel of the assignment of the order and/or corrective action.

2. The computerized method of claim 1 wherein the message includes a link for accessing the database through a respective interface medium including detailed information regarding the status of the order.

3. The computerized method of claim 2 wherein the interface medium comprises a Web page including a target date for performing the corrective action.

4. The computerized method of claim 3 wherein the Web page includes a data field for recording actions actually taken by the selected personnel to remove the lack of order progress.

5. The computerized method of claim 4 wherein the Web page further includes a data field for recording comment data regarding the status of the order and/or the actions taken to remove the lack of order progress.

6. The computerized method of claim 1 wherein the set of rules in the rule base is further configured to assign a lack of progress severity ratings based at least in part on continuing lack of progress beyond a fix completion date.

7. The computerized method of claim 1 wherein the rulebase further includes a set of escalation rules for progressively assigning corrective actions to higher levels of supervisory personnel based on a lack of progress severity ratings assigned to a respective order.

8. The computerized method of claim 1 wherein the plurality of teams are selected from the group consisting of an order-entry team, a goods-availability team, and a goods delivery team.

9. A computerized system for managing and communicating information regarding an order of goods among a plurality of teams responsible for performing tasks through designated personnel that, when successfully performed, allow for fulfilling an order within a requested delivery date, the system comprising:
a database comprising order data including at least one identifier associating a respective order to a respective customer, the order data further including a requested delivery date for the ordered goods, the database gathering data indicative of progress or lack thereof for each order relative to the requested delivery date;
memory for storing a rulebase including a set of rules configured to determine at least a potential cause impeding progress of any order relative to its respective requested delivery date, the set of rules being processable to assign an order and/or a corrective action to selected personnel in a respective team, based, at least in part, on the nature of the cause impeding order progress; and
processor configured to process the gathered data in the database relative to the rulebase for performing the assignment of the order and/or corrective action to the selected personnel in the event lack of order progress is determined, the processor further configured to issue a message notifying the selected personnel of the assignment of the order and/or corrective action.

10. The computerized system of claim 9 wherein the message includes a link for accessing the database through a respective interface medium including detailed information regarding the status of the order.

11. The computerized system of claim 10 wherein the interface medium comprises a Web page including a target date for performing the corrective action.

12. The computerized system of claim 11 wherein the Web page includes a data field for recording actions actually taken by the selected personnel to remove the lack of order progress.

13. The computerized system of claim 12 wherein the Web page further includes a data field for recording comment data regarding the status of the order and/or the actions taken to remove the lack of order progress.

14. The computerized system of claim 9 wherein the set of rules in the rule base is further configured to assign a lack of progress severity ratings based at least in part on continuing lack of progress beyond a fix completion date.

15. The computerized system of claim 9 wherein the rulebase further includes a set of escalation rules for progressively assigning corrective actions to higher levels of supervisory personnel based on a lack of progress severity ratings assigned to a respective order.

16. The computerized system of claim 9 wherein the plurality of teams are selected from the group consisting of an order-entry team, a goods-availability team, and a goods delivery team.
